(19) United States
(12) Patent Application Publication
(10) Pub. No.: US 2003/0121119 A1
(43) Pub. Date: Jul. 3, 2003

(54) Wiper brush arm and method for making same

(76) Inventors: Geraldine Benoit, Paris (FR); Isabelle Vendroux, Saint Babel (FR)

Correspondence Address: Andrew R Basile, Young & Basile, Suite 624, 3001 West Big Beaver Road, Troy, MI, 48084, US

(21) Appl. No.: 10/275,645

(22) PCT Filed: May 4, 2001
(86) PCT No.: PCT/FR01/01364

(30) Foreign Application Priority Data
May 11, 2000 (FR) 00/06014

(51) Int. Cl. B60S 1/32; B29C 45/16

(52) U.S. Cl. 15/250.351; 264/572; 264/255; 264/328.8

(57) ABSTRACT

A wiper brush arm for a motor vehicle includes a rigid molded plastic single-piece body having a generally elongated shape whereof one end is driven in reciprocating wiping movement, and the other end bears a wiper brush or a wiper blade. The body is coated at least partly with a protective layer protecting the body against external environmental attacks, such as ultraviolet radiation. The protective layer is made of plastic material.

### BACKGROUND

The invention concerns a wiper arm. The invention concerns more specifically a wiper arm for a motor vehicle also forming a brush, which is called a wiper brush.

The wiper arms are of a generally elongated shape and allow transmission of a reciprocating wiping movement of a drive head situated, for example, near the lower base of the front windshield or the rear window of a vehicle, to a wiper brush equipped with a wiping scraper.

The wiper arms must be sufficiently rigid in order to be able to transmit the reciprocating wiping movement without undergoing significant distortions. They are situated on the exterior of the vehicle and are visible, in particular, during the reciprocating wiping movement. Their aesthetics have a significant influence on the general exterior aspect of the vehicle.

A wiper arm can be made up of a metal profile, for example, a reverse U cross-section, which allows transmission of the wiping effort. However, exterior stresses, such as humidity and rain, can damage it, for example, by provoking the appearance of oxidation, in particular, rust. In such a manner as to protect the metallic profile, it is common knowledge to cover it with a protective layer such as paint.

The fabrication of such a wiper arm is costly. In effect, it contains a significant number of steps such as cutting a metallic side, its folding and its painting. In addition, a metallic wiper arm is heavy.

Another solution proposes creating a wiper brush arm comprising a single-piece body in a molded plastic material. The necessary mechanical rigidity necessitates the use of a reinforced material.

The exterior attacks, in particular, ultraviolet rays emitted by the sun, provoke a modification of the coloration of certain of these materials. For example, when a wiper arm is created in a thermoplastic material reinforced with fiberglass, the ultraviolet rays cause whitening of the piece. Such a phenomenon is unacceptable.

### SUMMARY

With the goal of remedying these inconveniences, the invention proposes a wiper arm, in particular, a motor vehicle brush arm of the type comprising a single-piece rigid body in a molded plastic material and having a generally elongated shape, an end of which is driven in reciprocating wiping movement and the other end bears a wiper brush or wiper blade, characterized in that the body is, at least in part, coated by a layer protecting the body against exterior attacks, such as ultraviolet rays, and in that the protective layer is made of a plastic material.

According to other characteristics of the invention:

the body comprises reinforcement means;

the reinforcement means consist of fibers, in particular, fiberglass;

the surfaces of the body and the protective layer in mutual contact include means for the mechanical coupling of the protective layer onto the body;

the coupling means consist of, at least in part, a chemical and/or physicochemical bond between the surfaces in mutual contact;

the coupling means consist of, at least in part, a coupling zone of one of the two elements, the shape of which cooperates with a second coupling zone complementary to the other element;

the protective layer envelopes the body at least in part;

the body is created in a reinforced material;

the reinforced material is, for example, polybutadene;

the protective layer is produced in a material resistant to climatic aging; and

the material resistant to climatic shift is acrylonitrile styrene acrylate;

The invention also proposes a process for making a wiper brush arm of the type described above characterized in that the body and the protective layer are produced simultaneously via molding, in particular, via injection molding, in only one mold impression in such a way that the protective layer envelopes the body at least in part.

According to other characteristics of the process, the invention proposes:

that the body and the protective layer be created in only one operation according to the technique of co-molding or bi-material molding;

that the body is produced at least in part with gas blowing during the injection in such a way as to form a hollow body;

that one makes the brush arm in two steps, in particular, via molding of the body during a first step, and by casting the protective layer around the body during a following step;

### BRIEF DESCRIPTION OF THE DRAWING

Other characteristics and advantages of the invention will appear in the detailed description which follows and for which one will refer to the attached drawings in which:

FIG. 1 is a schematic perspective view of a wiper comprising a brush arm in a plastic material made up of a body covered with a protective layer produced conforming to a first production method of the invention;

FIG. 2 is a transversal cross-section view of the brush arm wiper according to line 2-2 in FIG. 1;

FIG. 3 is a view similar to that represented in FIG. 2, the body and the protective layer comprising complementary coupling means;

FIG. 4 is a detailed view at a larger scale of a part of FIG. 3;

FIGS. 5a and 5b are views similar to that represented in FIG. 4, the coupling means being produced according to a another aspect of the invention;

FIGS. 6 to 9 represent, in a transversal cross-section, an injection mold of two brush arm wipers during different phases of fabrication of one of the brush arms; and

FIG. 10 is a view similar to that represented in FIG. 2, the brush arm wiper being produced according to a second production method of the invention.

### DETAILED DESCRIPTION

A plastic material can satisfy two required principal conditions with difficulty for a brush arm wiper, that is to say, a sufficient rigidity to limit the deformation of the brush arm during the reciprocating wiping movement and stability to the exterior attacks such as, for example, humidity and ultraviolet rays.

In order to do this, the invention proposes producing a wiper 10, in particular for a motor vehicle, comprising a brush arm 12 that is made up of a single-piece rigid body 14 molded in a plastic material and which is covered by a cover 16 protecting against exterior environmental attacks, which is also made of a polymer.

The body 14 allows transmission of the reciprocating wiping efforts of a first free end 18, that is, for example, linked to a drive bearing (not represented) in reciprocating rotation of a second free end 20, near which is attached a wiper brush 22 that supports a scraper 24 made of a polymer material that allows wiping of the window during wiping.

The body 14 can be produced in polybutadene terephtalate (PBT) which comprises reinforcement means. The reinforcement means can be fibers, such as fiberglass, that presents advantages, in particular, to improve the mechanical resistance of the PBT and to be inexpensive. However, the reinforcement means modify the appearance of the body 14, for example, by whitening under the climatic aging.

The protective layer 16 that covers at least in part the body 14 and which avoids the modification of its appearance, can be for example, produced in acrylonitrile styrene acrylate (ASA) or a base in an polybutadene terephtalate alloy. This is a stable material in relation to exterior attacks, in particular, ultraviolet rays.

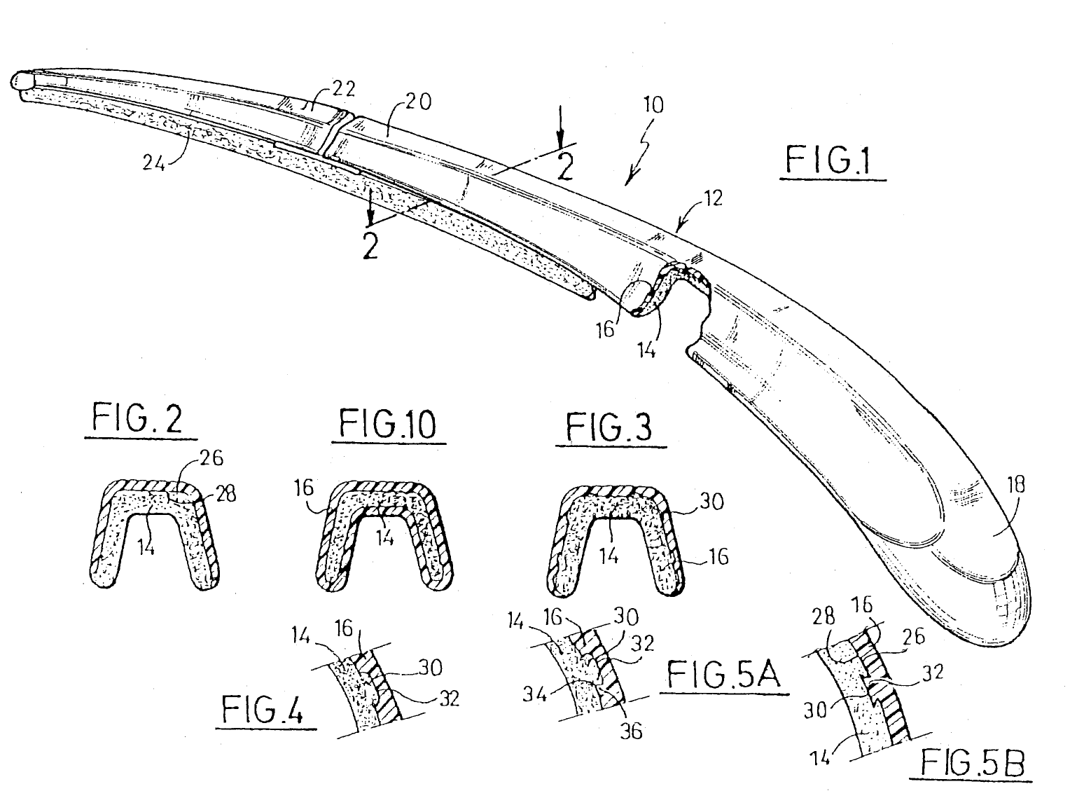

According to a first method of production, conforming to FIGS. 1 to 5b, the protective cover 16 covers only the sides or the exterior faces of the single-piece body 14 of the brush arm wiper 12.

It is thus necessary that the exterior side 26 of the body 14 and the internal side 28 of the protective cover 16, which are in mutual contact, comprise means for the mechanical coupling of the protective cover 16 onto the body 14. The coupling means can comprise a layer of glue which allows the adhesion of the exterior side 26 of the body 14 of the internal side 28 of the protective cover 16.

The coupling means can also consist at least in part of a chemical and/or physicochemical coupling between the sides 26 and 28 of the body 14 and of the protective layer 16 which are in mutual contact. That is to say, the plastic material constituents of the body 14 and of the protective envelope 16 present a good chemical compatibility in such a way so that during the fabrication of the brush arm 12, the chemical links are established between the materials of the body 14 and of the protective envelope 16 in such a way as to produce their coupling.

In this way, the polybutadene terephtalate-acrylonitrile styrene acrylate couple, for the body 14 and the protective envelope 16, respectively, present a good chemical compatibility.

In addition, conforming to FIGS. 3 and 4, the coupling means consist of, at least in part, in a first coupling zone 30 of the body 14 that reaches towards the exterior of the exterior side 26 in order to cooperate with a second coupling zone 32 in a complementary form produced in the internal side 28 of the protective cover 16. In this way, the contact surface between the exterior 26 and internal 28 sides is augmented which optimizes the coupling of the body 14 and of the protective layer 16. In addition, the penetration of the first coupling zone 30 of the body 14 in the second coupling zone 32 of the layer 16 improves the attachment of the two elements 14 and 16 to one another.

According to variations conforming to FIGS. 5a and 5b, the first coupling zone 30 presents a counter-cast 34 in a hollow form in which cooperate complementary projecting forms 36 from the protective layer 16. The mechanical coupling thus produced allows the protective layer 16 to be attached to the body 14. In a similar manner, FIG. 5b represents a transversal cross-section of the brush arm 12. The second coupling zone 32 reaches towards the exterior of the internal side 28 of the protective layer 16 in order to cooperate with the first coupling zone 30, in complementary shape, created in the external side 26 of the body 14.

The wiper brush arm 12 according to the first method of production can be obtained via molding, in two steps in the same mold or in two separate molds.

This molding technique is also called casting of plastic material.

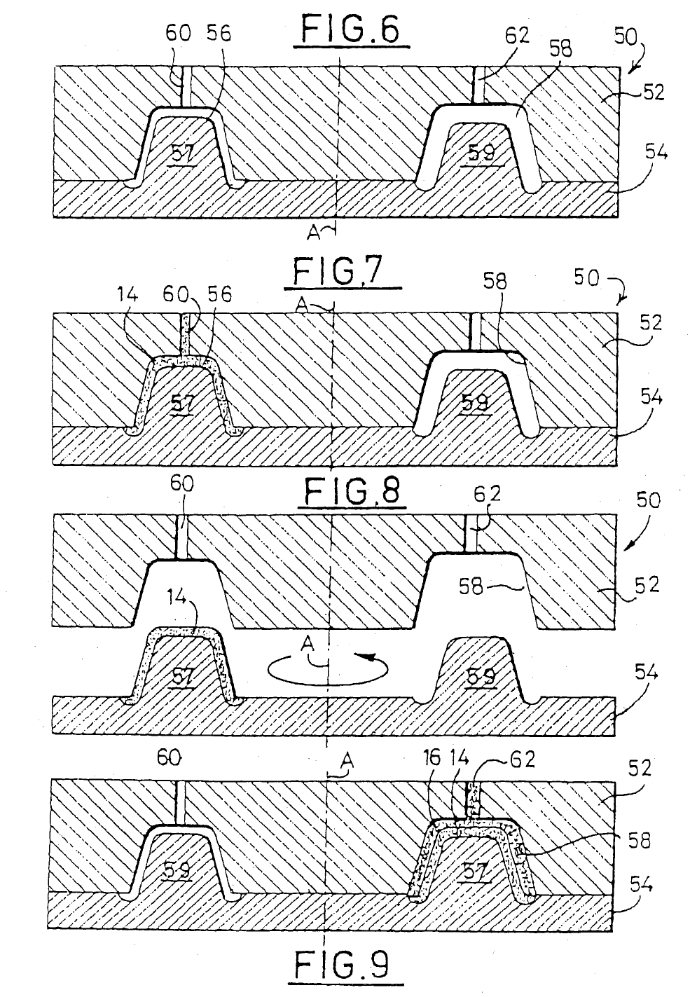

A mold 50 represented on FIGS. 6 to 9 comprises an upper part 52 and a lower part 54 in which are created two hollow impressions 56 and 58 which are linked to the exterior by two injection canals 60 and 62, respectively.

The impression form 56 corresponds to that of the body 14, and that of the impression 58 corresponds to the brush arm wiper 12 made up of the body and the protective cover 16.

The lower part 54 comprises a first and second, identical, ribs 57 and 59 which initially define the lower sides of the impressions 56 and 58 respectively.

During the first step, a device not represented allows heating of the plastic material, in particular granules of polybutadene terphtalate, reinforced by fiberglass, at a temperature set by transformation, in such a way as to “liquefy” it. The material is thus pressed to fill the first impression 56 of the mold 50, by a process that can be an injection method. The heating and injection of the plastic material are produced by a specific device called the plasticization screw.

The melted material is introduced in the mold 50 via the first injection canal 60 in such a way so that it fills the first impression 56, conforming to FIG. 7. A cooling device, not represented, which is produced in the upper 52 and the lower 54 parts of the mold 50 allows acceleration of the solidification of the injected material. The body 14 is thus completed.

The mold 50 is open, that is to say, that the lower part 54 is translated towards the bottom according to a vertical axis A. The body 14 stays attached to the lower part 54. In addition, conforming to FIG. 8, the core situated in the first injection canal 60 is removed. A rotation of 180 degrees around the vertical axis A is thus produced in such a way so that the body 14 and the rib 57 are vertically aligned with the second impression 58. Then, the mold 50 is closed again. During the second step, the protective “skin” 16 is molded onto the body 14.

As the plastic material, such as the acrylonitrile styrene acrylate is carried to its transformation temperature, when the mold 50 is closed, it is injected in the second injection canal 62 in order to fill the second impression 58, conforming to FIG. 9, in a similar manner as the first step. After cooling, the second impression 58 thus contains a wiper 10 brush arm 12 produced according to the invention.

The mold 50 is opened, and the wiper 10 and the brush arm 12 are separated from the rib 57. Another brush arm 12 can then be fabricated.

Advantageously, the first impression 56 is filled simultaneous with the filling of the second impression 58. In this way, a wiper 10 and a brush arm 12 is produced at each opening in the mold 50.

The casting technique allows, in particular, obtaining great precision as for the thickness of the protective layer 16 and the thickness of the body 14 over the length of the arm 10.

The above description of the first production method is not limited to the described steps. In effect, according to variants, the body 14 can be molded onto the protective layer 16, and/or the upper part 52 of the mold 50 can be mobile, and/or the injection of plastic can be created by injection canals situated in the upper part 54 of the mold 50.

The first production method can be obtained without rotation of part of the mold 50, but via transfer of the first part injected into the second impression.

According to a second method of production, the protective layer 16 entirely envelopes the body 14, conforming to the transversal section of the brush arm 14 represented on FIG. 10. The body 14 and the protective cover 16 can be simultaneously produced via molding, in particular, via injection of plastic materials in one single impression of a mold, not represented. The brush arm 12 is thus produced in only one operation, according to the co-molding, bi-molding or “sandwich” type of injection techniques. The two materials of the body 14 and the protective layer 16 are injected simultaneously during the same “shot” or injection. The dosage of the two materials is thus made in a shared plasticization screw.

Advantageously, during molding of the brush arm 12, gas can be blown into the mold simultaneously to the injection 12 of at least one of the two materials of the body 14 and/or of the protective layer 16 in such a way as to form a hollow brush arm 12.

What is claimed is:

1. Wiper (10) brush arm (12), in particular for a motor vehicle, of the type comprising a rigid molded plastic single-piece body (14) having a generally elongated shape one end (18) of which is driven in reciprocating wiping movement, and the other end of which (20) bears a wiper brush (22) or a wiper blade (24), characterized in that the body (14) is covered at least in part, by a layer (16) protecting the body (14) against exterior attacks, such as ultraviolet rays, and in that the protective layer (16) is a polymer.

2. Wiper (10) brush arm (12) according to the preceding claim, characterized in that the body (14) comprising reinforcement means.

3. Wiper (10) brush arm (12) according to the preceding claim, characterized in that the reinforcement means consist of fibers, in particular fiberglass.

4. Wiper (10) brush arm (12) according to any of the preceding claims, characterized in that the surfaces of the body (14) and the protective layer (16) in mutual contact comprising means (30, 32, 34, 36) for the mechanical coupling of the protective layer (16) onto the body (14).

5. Wiper (10) brush arm (12) according to the preceding claim, characterized in that the coupling means consist of at least in part a chemical or physicochemical coupling between the surfaces in mutual contact.

6. Wiper (10) brush arm (12) according to one of claims 4 or 5, characterized in that the coupling means consist of, at least in part, an coupling zone (30) of one of the two elements the shape of which cooperates with a second coupling zone (32) complementary to the other element.

7. Wiper (10) brush arm (12) according to any of the preceding claims, characterized in that the protective layer (16) envelopes at least in part, the body (14).

8. Wiper (10) brush arm (12) according to any of the preceding claims, characterized in that the body (14) is created in a reinforced material.

9. Wiper (10) brush arm (12) according to the preceding claim, characterized in that the reinforced material is Polybutadene Terephtalate.

10. Wiper (10) brush arm (12) according to any of the preceding claims, characterized in that the protective layer (16) is produced in a material resistant to climatic aging.

11. Wiper (10) brush arm (12) according to the preceding claim, characterized in that the material resistant to climatic shift is Acrylonitrile Styrene Acrilate.

12. Process for obtaining a wiper (10) brush arm (12) according to any of the preceding claims, characterized in that the body (14) and the protective layer (16) are simultaneously produced via molding, in particular via injection, in one single mold impression in such a way so that the protective layer (16) envelopes, at least in part, the body (14).

13. Process for obtaining a wiper (10) brush arm (12) according to the preceding claim, characterized in that the body (14) and the protective layer (16) are produced in only one operation according to the co-molding or bi-material molding technique.

14. Process for obtaining a wiper (10) brush arm (12) according to claims 12 or 13, characterized in that the body (14) is produced, at least in part, with gas blowing during the injection in such a way as to form a hollow body (14).

15. Process for obtaining a wiper (10) brush arm (12) according to any of claims 1 to 11, characterized in that one creates the brush arm (12) in two steps, in particular via molding of the body (14) during a first step, and via casting of the protective layer (16) around the body (14) during a following step.
